(19) United States
(12) Patent Application Publication
(10) Pub. No.: US 2002/0012488 A1
(43) Pub. Date: Jan. 31, 2002

(54) Switching system with a broadcast facility

(75) Inventor: Guy Franceus, Cheptainville (FR)

Correspondence Address: SUGHRUE, MION, ZINN,, MACPEAK & SEAS, PLLC, Suite 800, 2100 Pennsylvania Avenue, N.W., Washington, DC, 20037-3213, US

(73) Assignee: ALCATEL

(21) Appl. No.: 09/903,488

(22) Filed: Jul. 12, 2001

(30) Foreign Application Priority Data
Jul. 13, 2000 (FR) 00 09 202

(51) Int. Cl. G02B 6/35

(52) U.S. Cl. 385/16

(57) ABSTRACT

A switching system enabling broadcasting includes individual optical switching cells accepting α input signals and selecting β output signals. The switching cell has 1-to-p broadcasting capabilities and includes a first stage including α 1-to-p optical splitters, a second stage including p.α 1-to-β optical switches, and a third stage including β p.α-to-1 optical switches. Applications include the production of Clos networks.

### CROSS-REFERENCE TO RELATED APPLICATIONS

This application is based on French Patent Application No. 00 09 202 filed Jul. 13, 2000, the disclosure of which is hereby incorporated by reference thereto in its entirety, and the priority of which is hereby claimed under 35 U.S.C. §119.

### BACKGROUND OF THE INVENTION

1. Field of the invention

The present invention relates to transmitting information optically. In particular, it concerns optical routing switches used in optical networks.

2. Description of the Drior art

Communication networks must have functions that offer sophisticated services. They must be non-blocking and must allow broadcasting of received signals. Broadcasting received signals transmits the same signal to multiple destinations or routes the same signal over different paths.

The document JAJZSZCZYK ET AL,:“TEE TYPE PHOTONIC SWITCHING NETWORKS” IEEE NETWORK, IEEE INC. NEW-YORK, US, vol. 9, No. 1, 1995, pages 10-16, XP000486554, ISSN: 0890-8044 describes the use of architectures employing both spectral switching and space switching. These architectures have the property of enabling broadcasting of signals. The principle of these architectures consists of multiplexing a set of signals having a wavelength distribution preventing any interference. It is difficult to manage the situation of two signals having the same wavelength in accordance with this principle. The signals require additional processing in such cases.

Energy losses due to multiplexing must be compensated in such architectures, using broadband optical amplifiers. As a result, switching uses this type of architecture are relatively costly.

The object of the invention is to provide a non-blocking optical matrix having a broadcast capability and reduced insertion losses, without using reamplifier circuits.

### SUMMARY OF THE INVENTION

The invention provides a switching system enabling 1-to-N broadcasting, including:

a first stage consisting of N individual cells having α inputs and β outputs and enabling 1-to-p broadcasting, each cell including:

a first stage including α 1-to-p optical splitters;

a second stage including p.α 1-to-β optical switches; and

a third stage including β p.α-to-1 optical switches; and

a second stage consisting of N N×1 switches, each output of each cell being connected to one input of an N×1 switch.

The invention will be better understood after reading the following description, which refers to the accompanying drawings, which relate to a non-limiting embodiment.

### BRIEF DESCRIPTION OF THE DRAWINGS

FIG. 1 is the block diagram of an individual switching cell.

FIG. 2 shows one example of a switching system according to the invention.

FIG. 3 shows one embodiment of a closed network in accordance with the invention.

### DETAILED DESCRIPTION OF THE PREFERRED EMBODIMENT

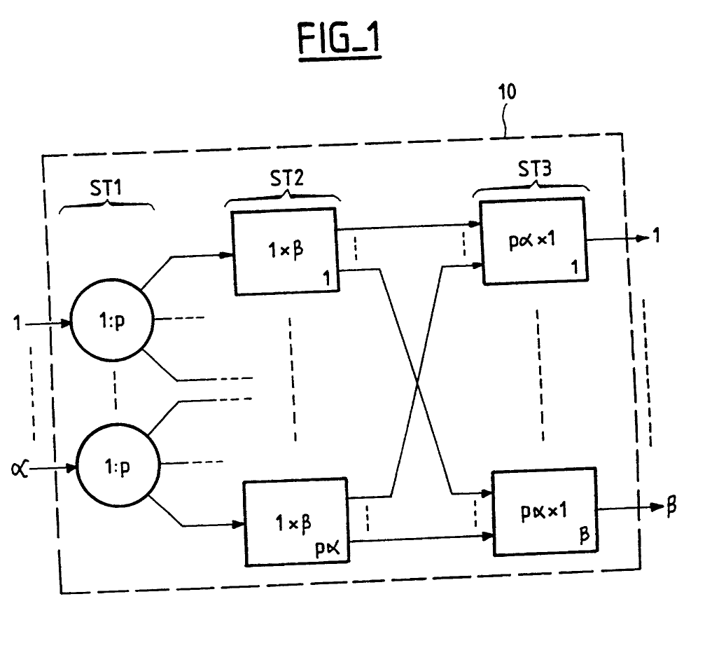

The individual cell shown in FIG. 1 accepts ax input signals and selects β output signals; it has 1-to-p broadcast capabilities. It includes:

a first stage ST1 including α 1-to-p optical splitters;

a second stage ST2 including p.α 1-to-β optical switches; and

a third stage ST3 including βp.α-to-1 optical switches.

Each optical splitter of the first stage ST1 has p outputs connected to a respective input of each of the switches of the second stage ST2. It creates p signals similar to an input signal. Each second stage switch has β outputs connected to a respective input of each of the switches of the third stage ST3. The number β is referred to as the expansion factor. The p signals that are broadcast can be routed by the switches of the second stage ST2 and the third stage ST3 to p respective outputs of the β outputs of the third stage.

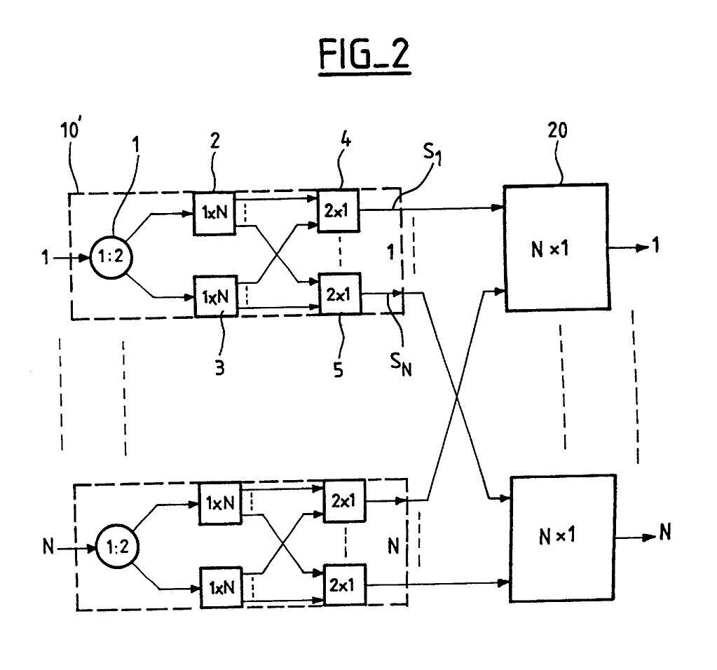

FIG. 2 shows one embodiment of an N-to-N switching system having a first stage consisting of N individual cells 10′, for 1-to-2 broadcasting, in accordance with the invention. In this example α=1, β=N, p=2. This example further includes a second stage consisting of N N-to-1 optical switches. The N inputs of each switch 20 are connected to a respective output of each of the N individual cells 10′.

Each individual cell 10′ includes a 1-to-2 optical splitter 1 whose two outputs are connected to respective inputs of the switch 2 and a 1-to-N switch 3. The N outputs of each of the switches 2 and 3 are each connected to the input of one of N 2-to-1 switches 4, . . . , 5 of the third stage of the individual cell 10′. Each signal applied to an input of a cell 10′ is split into two identical signals. Each of the switches 2 and 3 switches one of those two signals to one of its N outputs. Each switch 4, . . . , 5 selects a signal from two signals supplied to it by the switches 2 and 3. The system therefore outputs the signal applied to the input of the cell 10′ twice at N outputs S₁, . . . , S_{N} of the cell 10′.

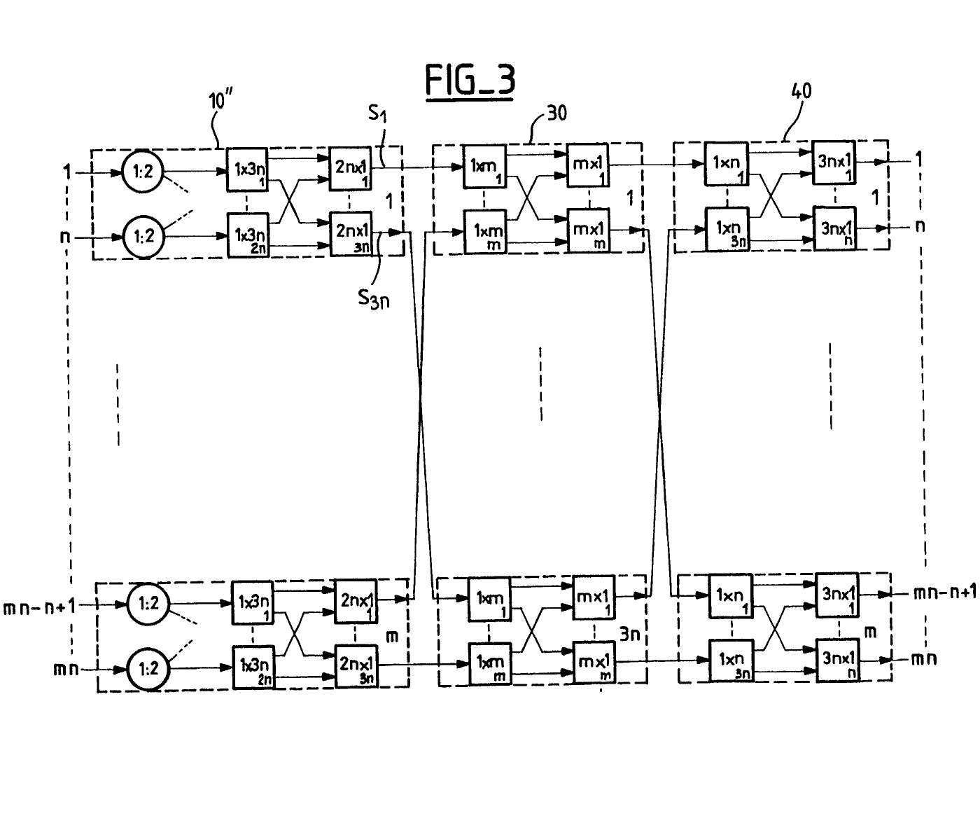

FIG. 3 shows one embodiment of a three-stage Clos network having a 1-to-2 broadcast capacity thanks to individual cells 10″.

The Clos network shown has a first stage consisting of m individual cells 10″ according to the invention, analogous to the cells 10 and 10′ described, each having n inputs and 3.n outputs S₁, . . . , S₃ₙ. The set of N individual cells 10″ has n.m inputs and 3.n.m outputs. The second stage is formed by a set of 3.n m-to-m matrices 30 whose inputs are connected to respective outputs of the individual cells 10″. The third stage consists of a set of m 3.n-to-n matrices 40 having a total of m.n outputs.

In this example, each individual cell 10″ has n inputs, and therefore α=n; also, β=3.n, p=2. As a general rule, to comply with the non-blocking condition, it is necessary to use an expansion factor β at least equal to 3.α−2, where α represents the number of inputs in each individual cell 10″ of the first stage. Each cell 10″ includes:

a first stage consisting of n 1-to-2 optical splitters;

a second stage consisting of 2.n 1-to-3.n switches, whose 2.n inputs are connected to 2.n respective outputs of the optical splitters; and

a third stage consisting of 3.n switches 2.n-to-1, the 2.n inputs of each switch being connected to a respective output of each of the second stage switches.

There is claimed:

1. A switching device enabling 1-to-N broadcasting, including
a first stage consisting of N individual cells having α inputs and β outputs and enabling 1-to-p broadcasting, each cell including:
a first stage including α 1-to-p optical splitters;
a second stage including p.α1-to-β optical switches; and
a third stage including βp.α-to-1 optical switches; and
a second stage consisting of N N×1 switches, each output of each cell being connected to one input of an N×1 switch.

2. The switching system claimed in claim 1 wherein α=1, β=N and p=2.

3. A Clos network enabling broadcasting, including a first stage including individual optical switching cells each having α inputs and β outputs and:
a first stage including α 1-to-p optical splitters;
a second stage including p.α1-to-β optical switches; and
a third stage including βp.α-to-1 optical switches.

4. The Clos network claimed in claim 3, wherein α=n, β=3.n, p=2.
